(19) United States
(12) Patent Application Publication
(10) Pub. No.: US 2006/0101652 A1
(43) Pub. Date: May 18, 2006

(54) Self gripping can opener

(76) Inventor: Shun So, Hksar (CN)

Correspondence Address: ALIX YALE & RISTAS LLP, 750 MAIN STREET, SUITE 1400, HARTFORD, CT, 06103, US

(21) Appl. No.: 10/988,080

(22) Filed: Nov. 12, 2004

(51) Int. Cl. B67B 7/70

(52) U.S. Cl. 30/418

(57) ABSTRACT

A lateral-cutting can opener has a body with a handle. A cutter is mounted with the body and is rotational about a first axis. A traction wheel is positioned on a shaft rotational about a second axis perpendicular to the first axis. The shaft is moveable in a direction lateral to the second axis between an inoperative position for receiving a rim of a can between the traction wheel and cutter, and an operative position for engaging a rim of a can between the traction wheel and cutter.

### BACKGROUND TO THE INVENTION

1. Field of the Invention

The invention relates to manually operable can openers, and in particular to can openers of the laterally-cutting type.

2. Background Information

Manually operable can openers have been known for many years and may be broadly categorised into three types: a first type having a cutter blade which cuts directly into the top wall of a can, a second type having a cutter blade which cuts into the side wall of the can below the rim, and a third type having a cutter blade which cuts partially into the rim of a can having a peripheral wall and ends joined by folding together edges of the wall and ends to form the rim.

The second and third types can be collectively referred to as laterally-cutting types, which are used to remove the end of a can at or below the can rim. Applicant's earlier patents GB 2334939 and GB 2341378 (and corresponding U.S. Pat. No. 6,058,613) describe a can opener that is of this laterally-cutting type.

A typical laterally-cutting type can opener comprises first and second elongate operating elements pivotally connected to each other. Each operating element has a handle portion. One operating element has a rotatable traction wheel pivotally opposite its handle, and the other operating element has a cutter blade pivotally opposite its handle. Movement of the handles relative to each other moves the traction wheel and cutter blade between an inoperative position to receive a rim of a can therebetween and an operative position in which the traction wheel and cutter blade engage the rim of the can. During operation of the can opener the two handles must be firmly held together in one hand while an operating handle is turned (to move the can rim between the cutter and traction wheel) with the other hand.

Two problems with the above can opener are that the best position for holding the handles together is often not the most comfortable position for using the opener, and it can be difficult for persons with a weak grip to squeeze the handles together with sufficient force during operation of the can opener to properly engage the can rim between the cutter and traction wheel.

### SUMMARY OF THE INVENTION

It is an object of the present invention to provide a lateral-cutting can opener that ameliorates the problems mentioned above or at least provides the public with a useful alternative.

According to the invention there is provided a lateral-cutting can opener comprising a body with a handle, a cutter mounted with the body and rotational about a first axis, a shaft having first and second ends mounted with the body and rotational about a second axis perpendicular to the first axis, a rotational traction wheel provided at the first end of the shaft, an operating element for rotating the shaft, and in which the shaft is moveable in a direction lateral to the second axis between an inoperative position for receiving a rim of a can between the traction wheel and cutter, and an operative position for engaging a rim of a can between the traction wheel and cutter.

Preferably, the shaft is rotatable in an operative direction and in an opposite inoperative direction and the can opener includes a cam interacting with the shaft to move the shaft towards the operative position when the shaft is rotated in the operative direction.

Preferably, the shaft is spring-biased into the inoperative position.

Preferably, the shaft is positioned in a curved slot in the body.

Preferably, the traction wheel has a frusta-conical face for forcing a rim of a can against the cutter.

Preferably, the body has a face for resting on an end of a can, the face being shaped for locating said rim between the traction wheel and cutter.

Preferably, the handle extends along a centreline having an in-use position perpendicular to an end of a can and within a boundary of a peripheral wall of said can.

Further aspects of the invention will become apparent from the following description, which is given by way of example only.

### BRIEF DESCRIPTION OF THE DRAWINGS

Embodiments of the invention will now be described with reference to the accompanying drawings in which:

FIG. 1 shows a lateral-cutting can opener according to the invention,

FIG. 2 shows an operational portion of the can opener in an operative configuration,

FIGS. 3 and 4 are a first side view of the can opener in inoperative and operative configurations respectively,

FIGS. 5 and 6 are a second side view of the can opener in the inoperative and operative configurations respectively,

FIG. 7 is a second side view of the operational portion of the can opener in the operative configuration, and

FIG. 8 is an end view of the can opener.

### DESCRIPTION OF THE PREFERRED EXAMPLES

In the drawings there is depicted a preferred embodiment of a lateral-cutting type can opener for cutting into the rim of a can having a peripheral wall and ends joined by folding together edges of the wall and ends to form the rim. The can opener has a body 1 shaped at one end to form a handle 2. The end of the body 1 opposite handle 2 has a face 3 for engaging an end of a can 4 to be opened.

Adjacent face 3 is a rotational cutter 5 with spindle 6 mounted with the body 1 for rotation about a cutter axis 7.

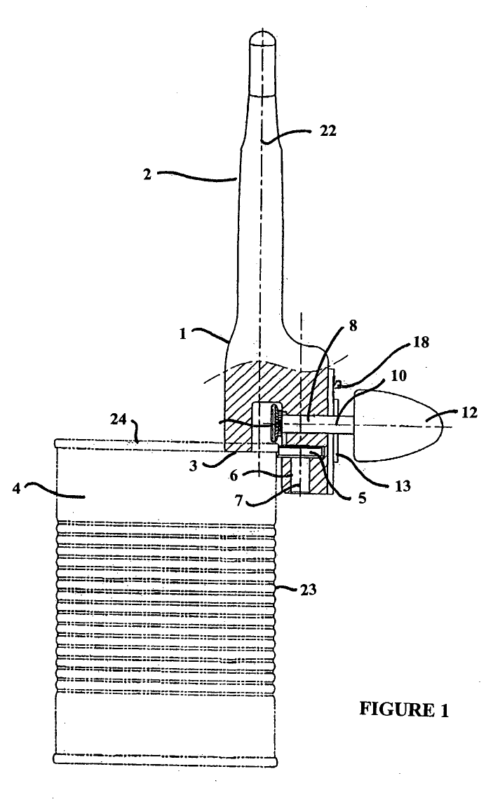

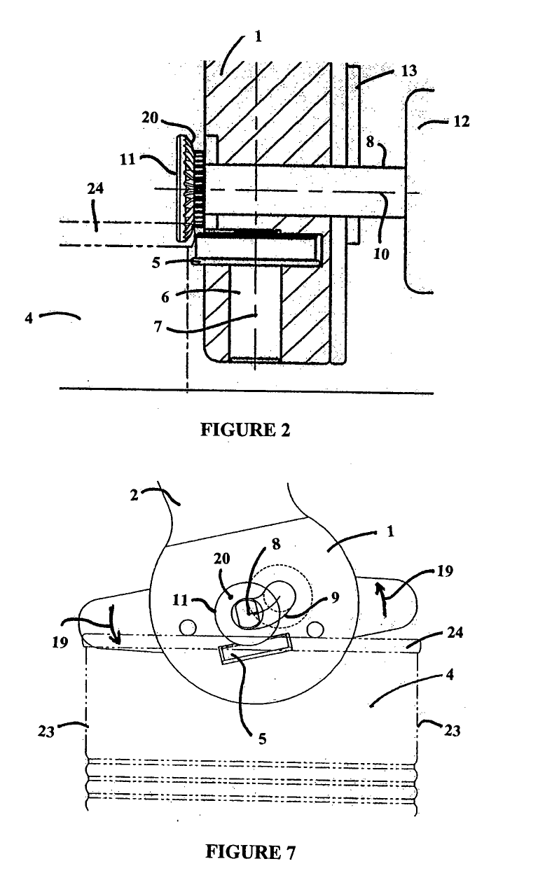

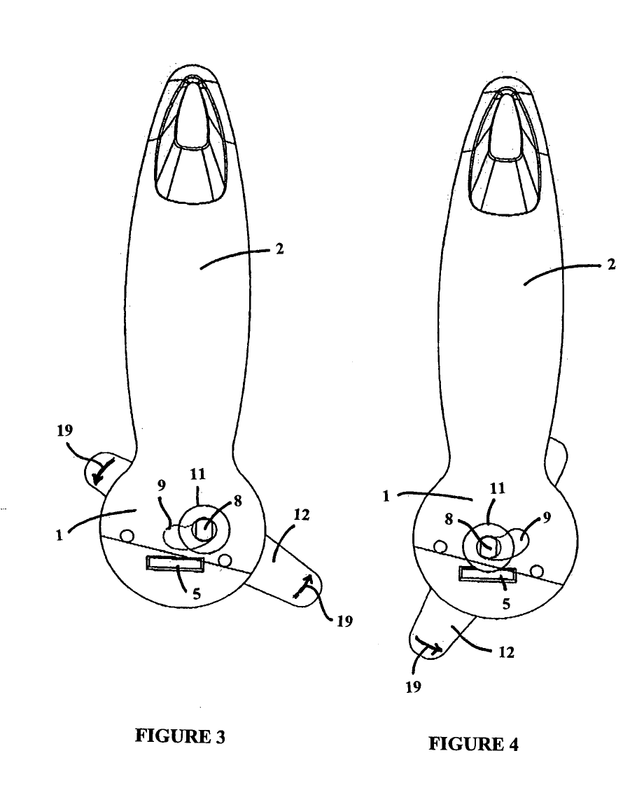

Adjacent cutter 5 is a rotational shaft 8 located within a curved slot 9 in the body 1. The shaft 8 is rotational about a second, operational, axis 10 that is perpendicular to the cutter axis 7. At one end of the shaft 8 is a traction wheel 11 and at the other end of the shaft 8 is a turning knob 12 for manual rotation of the shaft 8 and traction wheel 11. The shaft 8 is moveable within the slot 9 in a direction lateral to the operational axis 10 between an inoperative position for receiving a rim 24 of is a can 4 to be opened between the traction wheel 11 and cutter 5 and an operative position for engaging the rim 24 between the traction wheel 11 and cutter 5. The inoperative position is illustrated in FIGS. 1, 3 and 5. The operative position is illustrated in FIGS. 2, 4, 6 and 7.

The traction wheel 11 is provided with a frusta-conical face 20 for forcing the can rim 24 against the cutter 5 when the shaft 8 and traction wheel 11 are in the operative position. The frusta-conical face 20 is knurled to grip the can rim 24 during the opening operation.

A torsion spring 16 is provided between a fixed post 17 and shaft 8 for biasing the shaft 8 into the inoperative position.

A cam 13 is located on the shaft 8 between body 1 and turning knob 12. The cam 13 has an eccentric peripheral surface 14 with a radially extending step 15. A second fixed post 18 is provided for operating the cam 13.

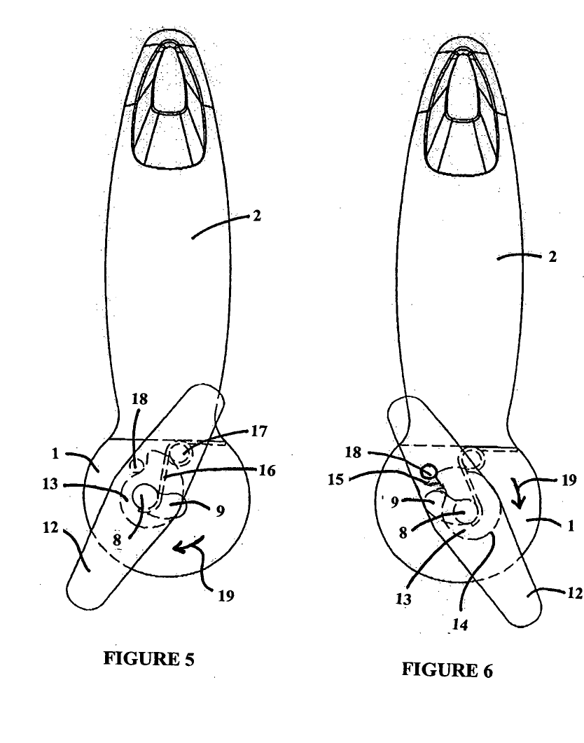

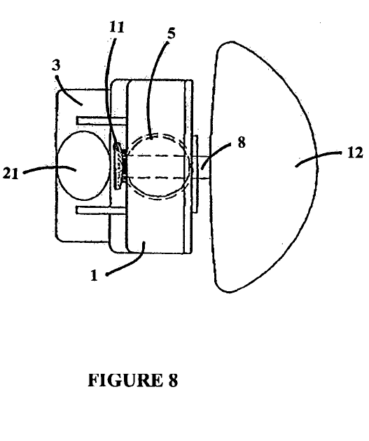

Using the turning knob 12 a user can rotate the shaft 8, and traction wheel 11, in a first, operative, direction for opening the can 4 or an opposite, inoperative, direction. The operative direction is indicated by arrows 19 in FIGS. 3 to 7. In FIGS. 3, 4 and 7 which shows a first side of the can opener the operative direction is anticlockwise and in FIGS. 5 and 6 which show a second side of the can opener the operative direction is clockwise. When shaft 8 is turned in the operative direction cam surface 14 moves against fixed post 18 causing shaft 8 to move within slot 9 towards the operative position.

Fixed post 18 is located a distance from the operative position of shaft 8 such that the cam 18 cannot complete a full 360 degree revolution which would return it to the inoperative configuration and allow shaft 8 to return to the inoperative position. It will be appreciated by the skilled addressee that cam 13 is not rotationally locked to shaft 8 but is frictionally engaged with shaft 8 such that rotation of shaft 8 moves the cam 13 while allowing shaft 8 to continue to rotate after cam 13 has moved through its full rotational limit.

The face 3 of body 1 has a protruding oval feature 21 which, when the can opener is positioned on the end of can 4, locates within the boundary of the peripheral wall 23 of can 4 to help locate the rim 24 between the traction wheel 11 and cutter 5.

As illustrated in FIG. 1 the handle 2 extends along a handle centreline 22 which has an in-use position substantially perpendicular to the end of can 4 and within a boundary of the peripheral wall 23 of can 4. Thus, the handle 2 extends substantially perpendicular from the end of can 4. When the can 4 is positioned upright on a bench or work surface (not shown) the can opener can be held in a natural, comfortable, position during the opening operation with the user's elbow bent and wrist straight. Because the centreline 22 of the handle 2 is located within the boundary of a peripheral wall 23 downwards pressure can be exerted on the can opener without tipping over the can 4.

Where in the foregoing description reference has been made to integers or elements having known equivalents then such are included as if individually set forth herein.

Embodiments of the invention have been described, however it is understood that variations, improvements or modifications can take place without departure from the spirit of the invention or scope of the appended claims.

1. A lateral-cutting can opener comprising:
a body with a handle,
a cutter mounted with the body and rotational about a first axis,
a shaft having first and second ends mounted with the body and rotational about a second axis perpendicular to the first axis,
a rotational traction wheel provided at the first end of the shaft,
an operating element for rotating the shaft,
the shaft moveable in a direction lateral to the second axis between an inoperative position for receiving a rim of a can between the traction wheel and cutter, and an operative position for engaging a rim of a can between the traction wheel and cutter.

2. The can opener of claim 1 wherein the shaft is rotatable in an operative direction and in an opposite inoperative direction and including a cam interacting with the shaft to move the shaft towards the operative position when the shaft is rotated in the operative direction.

3. The can opener of claim 1 wherein the shaft is spring-biased into the inoperative position.

4. The can opener of claim 1 wherein the shaft is positioned in a curved slot in the body.

5. The can opener of claim 1 wherein the traction wheel has a frusta-conical face for forcing a rim of a can against the cutter.

6. The can opener of claim 1 wherein the body has a face for resting on an end of a can, the face being shaped for locating said rim between the traction wheel and cutter.

7. The can opener of claim 1 wherein the handle extends along a centreline having an in-use position perpendicular to an end of a can and within a boundary of a peripheral wall of said can.

8. A lateral-cutting can opener comprising:
a body having a face and a handle extending along a centreline having an in-use position perpendicular to an end of a can and within a boundary of a peripheral wall of said can,
a cutter mounted with the body and rotational about a first axis parallel to the handle centreline,
a shaft having first and second ends mounted with the body and rotational about a second axis perpendicular to the handle centreline,
a rotational traction wheel provided at the first end of the shaft,
an operating element for rotating the shaft,
the shaft moveable in a direction lateral to the second axis between an inoperative position for receiving a rim of a can between the traction wheel and cutter, and an operative position for engaging a rim of a can between the traction wheel and cutter, and
the face having a feature for locating a rim of said can between the traction wheel and cutter.

9. The can opener of claim 8 wherein the shaft is rotatable in an operative direction and an opposite inoperative direction and including a cam interacting with the shaft to move the shaft towards the operative position when the shaft is rotated in the operative direction.

10. A lateral-cutting can opener comprising:
a body with a handle,
a cutter mounted with the body and rotational about a first axis,
a shaft having first and second ends positioned in a curved slot in the body and rotational about a second axis perpendicular to the first axis,
a rotational traction wheel provided at the first end of the shaft,
an operating element for rotating the shaft,
the shaft moveable in the slot between an inoperative position for receiving a rim of a can between the traction wheel and cutter, and an operative position for engaging a rim of a can between the traction wheel and cutter.

11. A lateral-cutting can opener comprising:
a body having a handle and a slot,
a cutter mounted with the body and rotational about a first axis,
a rotational shaft positioned in the slot and rotational in an operative direction about a second axis perpendicular to the first axis and moveable in the slot between an inoperative position and an operative position,
a traction wheel rotatable by the shaft, and
a cam interacting with the shaft to move the shaft towards the operative position when the shaft is rotated in the operative direction.
